(19) United States
(12) Patent Application Publication
(10) Pub. No.: US 2013/0243086 A1
(43) Pub. Date: Sep. 19, 2013

(54) WIRELESS TRANSMISSION TERMINAL AND WIRELESS TRANSMISSION METHOD, ENCODER AND ENCODING METHOD THEREFOR, AND COMPUTER PROGRAMS

(71) Applicant: Kenji Ooi, Kanagawa (JP)

(72) Inventor: Kenji Ooi, Kanagawa (JP)

(73) Assignee: PANASONIC CORPORATION, Osaka (JP)

(21) Appl. No.: 13/988,896

(22) PCT Filed: Dec. 12, 2011
(86) PCT No.: PCT/JP2011/006909

§ 371 Date: May 22, 2013

(30) Foreign Application Priority Data
Dec. 22, 2010 (JP) 2010-286447

(51) Int. Cl. H04N 7/32

(52) U.S. Cl. CPC H04N 19/00569
USPC 375/240.12

(57) ABSTRACT

A wireless moving image transmission terminal for encoding and wirelessly transmitting data comprises a moving image acquisition unit for acquiring data to be reproduced in time sequence, an encoder for encoding the data acquired in the moving image acquisition unit by inter-frame predictive encoding in units of frame and generating encoded data, a wireless transmission/reception unit for wirelessly transmitting the encoded data, a wireless state determination unit for determining a wireless state of the wireless transmission/reception unit, and when determining that the wireless state is deteriorated, interrupting transmission of the encoded data by the wireless transmission/reception unit, and a referenced frame designation unit for, when the wireless state determination unit interrupts transmission of the encoded data by the wireless transmission/reception unit , designating a referenced frame for inter-frame predictive encoding in the encoder.

### CROSS-REFERENCE TO RELATED APPLICATIONS

The present application claims the benefit of Patent Application No. 2010-286447 filed on Dec. 22, 2010 in Japan, the contents of which are incorporated herein by reference.

### TECHNICAL FIELD

The present invention relates to a wireless transmission terminal and wireless transmission method for encoding and wirelessly transmitting data to be reproduced in time sequence by inter-frame predictive encoding, an encoder for the wireless transmission terminal and an encoding method for the wireless transmission method, and computer programs for performing the methods.

### BACKGROUND ART

There has been conventionally known a movable terminal having the functions of shooting an object, generating moving image data, and wirelessly transmitting the generated moving image data (which will be called “wireless moving image transmission terminal” below). The wireless moving image transmission terminals typically include digital video cameras having a wireless communication function and capable of wirelessly transmitting generated moving image data, or wireless communication devices (such as cell phone) having the functions of shooting and transmitting moving images.

It is advantageous to encode moving image data by inter-frame predictive encoding when the moving image data is wirelessly transmitted from the wireless moving image transmission terminal. The inter-frame predictive encoding generates an in-frame encoding frame (I picture) obtained by encoding an input image itself at predetermined intervals, and generates a plurality of inter-frame encoding frames (P pictures or B pictures) obtained by encoding a difference between the input image and a predictive image between the I pictures, thereby remarkably compressing moving image data. In this way, the moving image data is compressed for transmission so that a transmission destination can receive the moving image data without delay and can reproduce moving images shot by the wireless moving image transmission terminal in real-time.

FIG. 3 is a configuration diagram of a wireless transmission system for wirelessly transmitting moving image data from a wireless moving image transmission terminal. As illustrated in FIG. 3, the wireless transmission system is provided with a plurality of access points. In the example of FIG. 3, the access points AP1 and AP2 are provided. The access points each cover their own wireless areas. In the example of FIG. 3, the access point AP1 covers a wireless area AR1 and the access point AP2 covers a wireless area AR2. As illustrated in FIG. 3, the wireless areas may partially overlap on each other.

The wireless moving image transmission terminal establishes an association with an access point of its belonging wireless area for making communication. In the example of FIG. 3, a wireless moving image transmission terminal TM1 makes communication with the access point AP1 covering the wireless area AR1, and a wireless moving image transmission terminal TM2 makes communication with the access point AP2 covering the wireless area AR2. The wireless moving image transmission terminals TM1 and TM2 transmit shot and generated moving image data to a monitor MT as a transmission destination via the access points AP1 and AP2 and relay devices RT such as a router, respectively.

When the wireless moving image transmission terminal moves, exits a current belonging wireless area and enters a new wireless area, handover is performed. The wireless moving image transmission terminal keeps shooting and keeps generating moving image data even while the handover is being performed. However, a processing of authenticating a new access point is performed during the handover, and thus a service disconnected period for several tens milliseconds to several seconds in which moving image data cannot be transmitted is caused. Thereby, the transmission destination cannot reproduce the moving images shot by the wireless moving image transmission terminal in real-time.

FIG. 4 is a diagram for explaining a moving image data transmission processing during handover according to a first conventional technique. The wireless moving image transmission terminal as a transmission source of moving image data includes an encoder for encoding the moving image data by inter-frame predictive encoding, and a wireless transmission/reception unit for packetizing and transmitting the encoded moving image data. A transmission destination of moving image data includes a reception unit for receiving the packets, and a decoder for decoding the moving image data received in the reception unit.

When moving image data is transmitted within a wireless cell in which the wireless moving image transmission terminal is present, the wireless transmission/reception unit makes the moving image data encoded by inter-frame predictive encoding in the encoder in IP packets and wirelessly transmits the same. In the transmission destination, the reception unit receives the same and the decoder decodes the moving image data. In FIG. 4, moving image data of frame 1 and frame 2 is transmitted from the wireless moving image transmission terminal to the transmission destination and is reproduced at the transmission destination as described above. The frames of the moving image shot in the wireless moving image transmission terminal can be reproduced at the transmission destination in real-time.

There is a time lag between when an object is shot by the wireless moving image transmission terminal and its moving image data is encoded and transmitted from the wireless moving image transmission terminal and when it is received and decoded at the transmission destination, and reproduction in “real-time” is that moving image data can be reproduced only in the time lag like the frame 1 or frame 2.

When the wireless moving image transmission terminal starts handover, the wireless moving image transmission terminal cannot transmit moving image data as described above. Thus, in the first conventional technique illustrated in FIG. 4, during handover, the wireless moving image transmission terminal stores packets of generated moving image data in a buffer, and transmits the packets stored in the buffer to a new access point after the handover is completed. In the example of FIG. 4, packets of the moving image data in frames 3, 4, 5 generated during handover are stored in the buffer and are sequentially transmitted after the handover is completed.

According to the first conventional technique, reproduction of the frames which cannot be transmitted during handover is delayed at the transmission destination, but all the frames can be reproduced irrespective of interruption of data transmission due to the handover. However, according to the first conventional technique, the wireless moving image transmission terminal needs a buffer with a sufficient capacity for storing moving image data generated during handover. When the wireless moving image transmission terminal is a small portable device such as cell phone or digital video camera, it is difficult to secure such a buffer with a sufficient capacity.

FIG. 5 is a diagram for explaining a case in which overflow occurs in a buffer when moving image data during handover is stored in a buffer even when the buffer does not have a sufficient capacity. In the case of FIG. 5, as a result of the overflow of the buffer, all the packets of the frame 3 and part of the packets of the frame 4 are discarded. Thus, also after handover is completed, the frame 3 cannot be reproduced in a transmission destination, and only part of the packets of the frame 4 is present and thus cannot be completely reproduced.

In the case of FIG. 5, the frame 3 or the frame 4 whose part of or total packets are not transmitted cannot be reproduced, and due to a cause described later, even the frame 5 and its subsequent frames whose total packets are transmitted after handover is completed are deteriorated in an image quality of the reproduced image at the transmission destination.

As illustrated in FIG. 5, the moving image frames include I pictures and P pictures. The I picture is an image which is a start point of reproducing moving images and which is encoded by in-frame predictive encoding. The P picture is a frame which is encoded by forward inter-frame predictive encoding from a former I picture or P picture.

With reference to FIG. 5, the frame 1 and the frame 2 are packetized and all the packets are completely transmitted to the transmission destination. Since handover is started at the wireless moving image transmission terminal after the frame 2 is transmitted, the frame 3 and its subsequent frames are stored in the buffer in the service disconnected period. However, since the buffer does not have an enough capacity to store the packets for three frames, part of the packets of the frame 3 is discarded when the packets of the frame 5 are stored.

The handover is completed before the frame 6 is completely encoded, and the wireless moving image transmission terminal enters communicable with a new access point, but the packets of the frame 6 are stored in the buffer before the communication is restarted to transmit part of the packets of the frame 3, and thus the packets of the frame 3 and part of the packets of the frame 4 are discarded. Thus, when the handover is completed and the packets are transmitted to the new access point, the buffer stores all the packets of the frame 6 and the frame 5 and only part of the packets of the frame 4. Therefore, even when transmission is restarted after the handover is completed, only part of the packets of the frame 4 can be transmitted. The packets stored in the buffer are sequentially transmitted from the frame 5 to the frame 7 after the handover is completed, thereby completely transmitting one frame. The frame 8 and its subsequent frames can be transmitted as usual.

The transmission destination receives complete data for the frame 5 but needs moving image data of the frame 4 for decoding the frame 5, but part of the packets of the frame 4 is missing and complete moving image data cannot be obtained as described above, and thus the image quality of the frame 5 is deteriorated.

The encoded data of the frame 6 and the frame 7 is transmitted to the transmission destination, but the image quality of the frame 5 and the frame 6 to be referred to is deteriorated, and thus the image quality of the frame 6 and the frame 7 is deteriorated.

In this way, once handover is started and transmission is interrupted, even if the handover is then completed and the transmission is restarted, the frames cannot be normally reproduced until a next I picture at the transmission destination. Thus, according to the first conventional technique, it is not possible to sufficiently reduce the frames which cannot be normally reproduced due to handover while restricting the capacity of the buffer required for the wireless moving image transmission terminal.

To the contrary, according to a second conventional technique (Patent Literature 1), frames after the wireless moving image transmission terminal starts handover are subjected to in-frame encoding to be assumed as I pictures. According to the second conventional technique, the frames after the handover is started are subjected to in-frame encoding (for a certain period after the handover is completed as needed) so that complete reproduction can be performed immediately after the handover is completed.

### CITATION LIST

### Patent Literature

Patent Literature 1: International Publication No. 2003/041408 pamphlet

### SUMMARY OF INVENTION

### Technical Problem

According to the second conventional technique, however, since moving image data to be stored in the buffer during handover is in-frame encoding frames (I pictures), the number of frames capable of being stored in the buffer is less than when moving image data is inter-frame encoding frames (P pictures or B pictures). For example, in the example of FIG. 5, it is assumed that the buffer does not have a capacity for storing the I pictures for two frames. In this case, when the packets of the frame 6 are buffered, part of or all the packets of not only the frame 4 but also the frame 5 are discarded and the frame 5 cannot be completely reproduced.

Thus, according to the second conventional technique, it is not possible to sufficiently reduce the frames which cannot be normally reproduced in a service disconnected period due to handover while restricting the capacity of the buffer required for the wireless moving image transmission terminal.

The present invention has been made in terms of the above problems, and an object thereof is to provide a wireless transmission terminal capable of reducing the number of frames which cannot be normally reproduced in a service disconnected period (including when reproduction cannot be completely performed, when reproduction is incomplete and when an image quality of a reproduced image is deteriorated, but limited thereto) while restricting a capacity of a buffer required for the wireless transmission terminal.

### Solution to Problem

In order to solve the above conventional problems, the wireless transmission terminal according to the present invention is a wireless transmission terminal for encoding and wirelessly transmitting data to be reproduced in time sequence, comprising a data acquisition unit for acquiring the data to be reproduced in time sequence, an encoder for encoding the data acquired in the data acquisition unit by inter-frame predictive encoding in units of frame and generating encoded data, a wireless transmission unit for wirelessly transmitting the encoded data, a wireless transmission control unit for determining a wireless state of the wireless transmission unit, and when determining that the wireless state is deteriorated, interrupting transmission of the encoded data by the wireless transmission unit, and a referenced frame designation unit for, when the wireless transmission control unit interrupts transmission of the encoded data by the wireless transmission unit, designating a referenced frame for the inter-frame predictive encoding in the encoder.

The wireless transmission terminal may further includes a buffer for storing the encoded data to be transmitted by the wireless transmission unit while the wireless transmission control unit interrupts transmission of the encoded data by the wireless transmission unit.

In the wireless transmission terminal, the referenced frame designation unit may designate, as the referenced frame, a frame decodable among frames transmitted before the wireless transmission control unit interrupts transmission of the encoded data by the wireless transmission unit.

In the wireless transmission terminal, the referenced frame designation unit may designate, as the referenced frame, the decodable latest frame among frames transmitted before the wireless transmission control unit interrupts transmission of the encoded data by the wireless transmission unit.

In the wireless transmission terminal, after the wireless transmission control unit determines that the wireless state is recovered, the wireless transmission unit may transmit the encoded data stored in the buffer.

In the wireless transmission terminal, after the wireless transmission control unit determines that the wireless state is recovered, the referenced frame designation unit may cancel designating the referenced frame.

In the wireless transmission terminal, after the wireless transmission control unit determines that the wireless state is recovered, and a predetermined number of frames are encoded by the designated referenced frame, the referenced frame designation unit may cancel designating the referenced frame.

In the wireless transmission terminal, when receiving the encoded data exceeding a capacity of the buffer, the buffer may discard the stored encoded data in units of frame.

In the wireless transmission terminal, the buffer may discard the stored encoded data sequentially from the oldest data.

In the wireless transmission terminal, the buffer may discard the stored encoded data at predetermined frame intervals sequentially from the oldest data.

In the wireless transmission terminal, the wireless transmission unit may further include a reception function, and while a reception intensity of the wireless transmission unit is equal to or less than a predetermined threshold, the wireless transmission control unit may interrupt transmission of the encoded data by the wireless transmission unit.

In the wireless transmission terminal, until handover is completed after the wireless transmission terminal starts the handover, the wireless transmission control unit may interrupt transmission of the encoded data by the wireless transmission unit.

Another aspect of the present invention is an encoding device used for a wireless transmission terminal comprising a data acquisition unit for acquiring data to be reproduced in time sequence, a wireless transmission unit for encoding the data to be reproduced in time sequence by inter-frame predictive encoding in units of frame and wirelessly transmitting the encoded data, and a wireless transmission control unit for determining a wireless state of the wireless transmission unit, and when determining that the wireless state is deteriorated, interrupting transmission of the encoded data by the wireless transmission unit, the encoding device comprising an encoder for encoding the data acquired in the data acquisition unit and reproduced in time sequence by inter-frame predictive encoding in units of frame and generating the encoded data, and a referenced frame designation unit for, when the wireless transmission control unit interrupts transmission of the encoded data by the wireless transmission unit, designating a referenced frame for the inter-frame predictive encoding by the encoder.

Still another aspect of the present invention is a wireless transmission method for encoding and wirelessly transmitting data to be reproduced in time sequence, comprising a data acquisition step of acquiring the data to be reproduced in time sequence, an encoding step of encoding the data acquired in the data acquisition step by inter-frame predictive encoding in units of frame and generating encoded data, a wireless transmission step of wirelessly transmitting the encoded data; a wireless transmission control step of determining a wireless state, and when determining that the wireless sate is deteriorated, interrupting transmission of the encoded data, and a referenced frame designation step of, when the wireless transmission control step interrupts transmission of the encoded data, designating a referenced frame for the inter-frame predictive encoding in the encoding step.

Still another aspect of the present invention is an encoding method performed in a wireless transmission terminal comprising a data acquisition unit for acquiring data to be reproduced in time sequence, a wireless transmission unit for encoding the data to be reproduced in time sequence by inter-frame predictive encoding in units of frame, and wirelessly transmitting the encoded data, and a wireless transmission control unit for determining a wireless state of the wireless transmission unit, and when determining that the wireless state is deteriorated, interrupting transmission of the encoded data by the wireless transmission unit, the encoding method comprising an encoding step of encoding the data acquired in the data acquisition unit and reproduced in time sequence by inter-frame predictive encoding in units of frame and generating the encoded data, and a referenced frame designation step of, when the wireless transmission control unit interrupts transmission of the encoded data by the wireless transmission unit, designating a referenced frame for the inter-frame predictive encoding in the encoding step.

Still another aspect of the present invention is a computer program for causing a computer to perform the wireless transmission method.

Still another aspect of the present invention is a computer program for causing a computer to perform the encoding method.

### Advantageous Effects of Invention

According to the present invention, since an inter-frame encoding frame is generated also while transmission of encoded data by the wireless transmission unit is being interrupted, a capacity of the buffer required for the wireless transmission terminal can be restricted, and at the same time, while transmission of encoded data by the wireless transmission unit is being interrupted, a referenced frame for inter-frame predictive encoding is designated, and thus the number of frames which cannot be normally reproduced in a service disconnected period can be reduced.

As described above, other aspects of the present invention are provided. Thus, the disclosure of the present invention intends to provide part of the present invention, and does not intend to limit the scope of the present invention described and claimed herein.

### BRIEF DESCRIPTION OF DRAWINGS

FIG. 1 is a configuration diagram of a wireless moving image transmission terminal according to an embodiment of the present invention.

FIG. 2 is an explanatory diagram of a moving image data transmission processing according to the embodiment of the present invention.

FIG. 3 is a configuration diagram of a system for wirelessly transmitting moving image data from the wireless moving image transmission terminal.

FIG. 4 is an explanatory diagram of a moving image data transmission processing according to a first conventional technique.

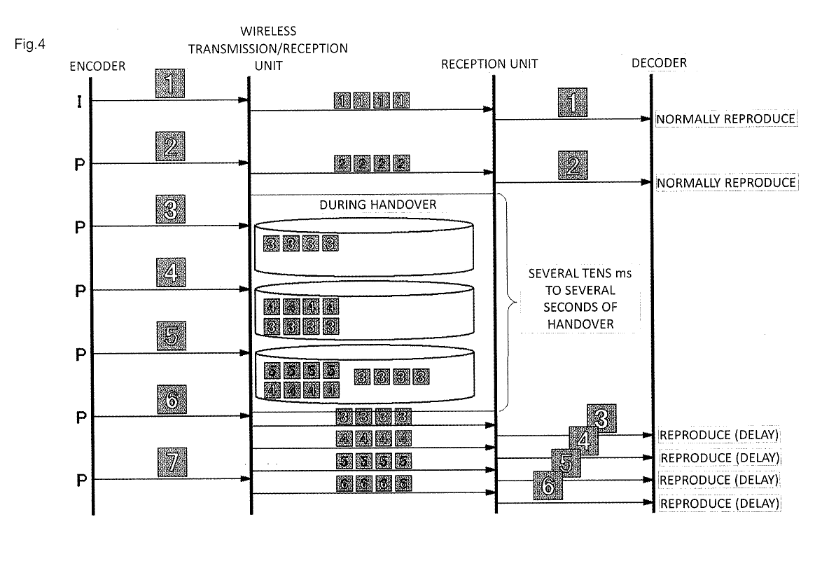

FIG. 5 is an explanatory diagram of a case in which overflow occurs in a buffer in the moving image data transmission processing according to the first conventional technique.

### DESCRIPTION OF EMBODIMENTS

The present invention will be described below in detail. The embodiment of the present invention described later is merely exemplary, and the present invention may be variously modified. Specific structures and functions disclosed later do not intend to limit the scope of claims.

A wireless transmission terminal is directed for encoding and wirelessly transmitting data to be reproduced in time sequence. The wireless transmission terminal includes a data acquisition unit for acquiring data to be reproduced in time sequence, an encoder for encoding the data acquired in the data acquisition unit by inter-frame predictive encoding in units of frame and generating encoded data, a wireless transmission unit for wirelessly transmitting the encoded data, and a wireless transmission control unit for determining a wireless state of the wireless transmission unit, and when determining that the wireless state is deteriorated, interrupting transmission of the encoded data by the wireless transmission unit, and a referenced frame designation unit for, when the wireless transmission control unit interrupts transmission of the encoded data by the wireless transmission unit, designating a referenced frame for inter-frame predictive encoding in the encoder.

With the structure, since not in-frame encoding frames but inter-frame encoding frames are generated also while transmission of the encoded data by the wireless transmission unit is being interrupted, a small capacity of a buffer is required for storing the frames, and a small amount of data to be transmitted is required for transmitting the stored encoded data after wireless communication is restarted. While transmission of the encoded data by the wireless transmission unit is being interrupted, the referenced frame designation unit designates a referenced frame for inter-frame predictive encoding in the encoder, thereby avoiding a situation where a transmission destination cannot decode a referenced frame of the encoded data transmitted after the wireless state is recovered and the transmission of the encoded data is restarted. The data to be reproduced in time sequence may be moving image data, or speech data or both of them. The inter-frame predictive encoding may be encoding including in-frame encoding frames (I pictures) and forward predictive frames (P pictures), and encoding including bidirectional predictive frames (B pictures).

The wireless transmission terminal may further include a buffer for storing encoded data to be transmitted by the wireless transmission unit while the wireless transmission control unit interrupts transmission of the encoded data by the wireless transmission unit.

With the structure, it is possible to avoid a situation in which the encoded data stored in the buffer cannot be decoded due to an absence of a referenced frame at a transmission destination while the transmission of the encoded data is interrupted.

In the wireless transmission terminal, the referenced frame designation unit may designate, as a referenced frame, a decodable frame among the frames transmitted before the wireless transmission control unit interrupts transmission of the encoded data by the wireless transmission unit.

With the structure, all the frames encoded when the referenced frame is fixed can be decoded at the transmission destination.

In the wireless transmission terminal, the referenced frame designation unit may designate, as a referenced frame, a decodable latest frame among the frames transmitted before the wireless transmission control unit interrupts transmission of the encoded data by the wireless transmission unit.

With the structure, all the frames encoded when the referenced frame is fixed can be decoded at the transmission destination, and the referenced frame is made closer to the encoded frames, so that the encoded data stored in the buffer after wireless communication is interrupted can be decoded into higher-quality data when being decoded at the transmission destination after the wireless communication is restarted.

In the wireless transmission terminal, the wireless transmission unit may transmit the encoded data stored in the buffer after the wireless transmission control unit determines that the wireless state is recovered.

With the structure, the encoded data encoded and stored in the buffer after wireless communication is interrupted can be decoded at the transmission destination after the wireless communication is restarted, and missing data due to the interrupted wireless communication can be reduced.

In the wireless transmission terminal, the referenced frame designation unit may cancel designating a referenced frame after the wireless transmission control unit determines that the wireless state is recovered.

With the structure, after wireless communication is restarted, normal inter-frame predictive encoding for which a referenced frame is not fixed can be restarted, thereby efficiently compressing data.

In the wireless transmission terminal, the referenced frame designation unit may cancel designating a referenced frame after the a predetermined number of frames are encoded at the designated referenced frame when the wireless transmission control unit determines that the wireless state is recovered.

When typical inter-frame predictive encoding for which a referenced frame is not fixed performs encoding with reference to a frame before multiple frames, a designated referenced frame is canceled immediately after the wireless state is recovered and wireless communication is restarted, so that the referenced frame for the frames encoded by the typical inter-frame predictive encoding immediately after the wireless communication is restarted is a frame to be discarded in the buffer, and consequently cannot be decoded. To the contrary, with the structure, a predetermined number of frames after the wireless state is determined to be recovered are subsequently encoded with the designated referenced frame, thereby avoiding the disadvantage.

In the wireless transmission terminal, the buffer may discard the stored encoded data in units of frame when receiving the encoded data exceeding the capacity of the buffer.

With the structure, when one frame of data is divided into a plurality of packets and is stored in the buffer in units of packet, only part of the packets is left in the buffer and the rest of the packets is discarded, thereby avoiding incomplete reproduction of the frames at a transmission destination.

In the wireless transmission terminal, the buffer may discard the stored encoded data sequentially from the oldest data.

With the structure, when encoded data exceeding the capacity of the buffer is generated, the new encoded data can be preferentially stored and the wireless communication is restarted to transmit the encoded data stored in the buffer to the transmission destination, thereby reproducing the new frames at the transmission destination.

In the wireless transmission terminal, the buffer may discard the stored encoded data at predetermined frame intervals sequentially from the oldest data.

With the structure, when encoded data exceeding the capacity of the buffer is generated, the encoded data can be intermittently stored and the wireless communication is restarted to transmit the encoded data stored in the buffer to the transmission destination so that the data frames can be intermittently reproduced at the transmission destination, thereby avoiding collective time data after the wireless communication is interrupted from missing.

In the wireless transmission terminal, the wireless transmission unit may further include a reception function, and the wireless transmission control unit may interrupt transmission of encoded data by the wireless transmission unit while a reception intensity of the wireless transmission unit is equal to or less than a predetermined threshold.

With the structure, whether the wireless state is good can be determined depending on the reception intensity, and until the reception intension is recovered after the reception intensity is lowered (until handover is completed after the handover is started, until an obstacle is eliminated and the wireless state is recovered from the deteriorated wireless state due to the obstacle in the wireless area, and until the terminal returns to a wireless area after it exits the wireless area, but not limited thereto), transmission of the encoded data is interrupted, and the data can be encoded by inter-frame predictive encoding for which a referenced frame is designated during the interruption.

In the wireless transmission terminal, the wireless transmission control unit may interrupt transmission of encoded data by the wireless transmission unit until handover is completed after the wireless transmission terminals starts the handover.

With the structure, encoding with a designated referenced frame can be performed in a service disconnected period due to the handover processing, and the number of frames which cannot be retransmitted can be reduced at the transmission destination in the service disconnected period due to the handover processing.

Another aspect of the present invention is an encoding device used for a wireless transmission terminal comprising a data acquisition unit for acquiring data to be reproduced in time sequence, a wireless transmission unit for encoding the data to be reproduced in time sequence by inter-frame predictive encoding in units of frame and wirelessly transmitting the encoded data, and a wireless transmission control unit for determining a wireless state of the wireless transmission unit, and when determining that the wireless state is deteriorated, interrupting transmission of the encoded data by the wireless transmission unit, the encoding device comprising an encoder for encoding the data acquired in the data acquisition unit and reproduced in time sequence by inter-frame predictive encoding in units of frame and generating encoded data, and a referenced frame designation unit for, when the wireless transmission control unit interrupts transmission of the encoded data by the wireless transmission unit, designating a referenced frame for the inter-frame predictive encoding in the encoder.

With the structure, while the transmission of the encoded data by the wireless transmission unit is being interrupted, the inter-frame encoding frames are generated so that the capacity for the encoded data is smaller, which is advantageous for storage and transmission. While the transmission of the encoded data by the wireless transmission unit is being interrupted, the referenced frame designation unit designates a referenced frame for the inter-frame predictive encoding in the encoder, thereby avoiding a situation in which the encoded data transmitted after the wireless state is recovered and the transmission of the encoded data is restarted cannot be decoded due to an absence of a referenced frame at the transmission destination.

Still another aspect of the present invention is a wireless transmission method for encoding and wirelessly transmitting data to be reproduced in time sequence, the wireless transmission method comprising a data acquisition step of acquiring data to be reproduced in time sequence, an encoding step of encoding the data acquired in the data acquisition step by inter-frame predictive encoding in units of frame and generating encoded data, a wireless transmission step of wirelessly transmitting the encoded data, a wireless transmission control step of determining a wireless state, and when determining that the wireless state is deteriorated, interrupting transmission of the encoded data, and a referenced frame designation step of, when transmission of the encoded data is interrupted in the wireless transmission control step, designating a referenced frame for the inter-frame predictive encoding in the encoding step.

With the structure, while transmission of the encoded data is being interrupted, inter-frame encoding frames are generated, and thus the capacity for the encoded data is smaller, which is advantageous for storage and transmission. When transmission of the encoded data is being interrupted, a referenced frame for the inter-frame predictive encoding is designated, thereby avoiding a situation in which the encoded data transmitted after the wireless state is recovered and the transmission of the encoded data is restarted cannot be decoded due to an absence of a referenced frame in the transmission destination.

Still another aspect of the present invention is an encoding method performed in a wireless transmission terminal comprising a data acquisition unit for acquiring data to be reproduced in time sequence, a wireless transmission unit for encoding the data to be reproduced in time sequence by inter-frame predictive encoding in units of frame and wirelessly transmitting the encoded data, and a wireless transmission control unit for determining a wireless state of the wireless transmission unit, and when determining that the wireless state is deteriorated, interrupting transmission of the encoded data by the wireless transmission unit, the encoding method comprising an encoding step of encoding the data acquired in the data acquisition unit and reproduced in time sequence by inter-frame predictive encoding in units of frame and generating encoded data, and a referenced frame designation step of, when the wireless transmission control unit interrupts transmission of the encoded data by the wireless transmission unit, designating a referenced frame for the inter-frame predictive encoding in the encoding step.

With the structure, while transmission of the encoded data is being interrupted, the inter-frame encoding frames are generated so that the capacity for the encoded data is smaller, which advantages for storage and transmission. While transmission of the encoded data is being interrupted, a referenced frame for the inter-frame predictive encoding is designated, thereby avoiding a situation in which the encoded data transmitted after the wireless state is recovered and the transmission of the encoded data is restarted cannot be decoded due to an absence of a referenced frame in the transmission destination.

Still another aspect of the present invention is a computer program for causing a computer to perform the wireless transmission method.

Still another aspect of the present invention is a computer program for causing a computer to perform the encoding method.

The embodiment of the present invention will be described below with reference to the drawings. The present invention relates to a wireless transmission terminal for encoding and wirelessly transmitting data to be reproduced in time sequence, but in the following embodiment, there will be described an exemplary wireless moving image transmission terminal in which data is moving image data and a wireless transmission terminal wirelessly transmits moving image data. The data to be transmitted in the wireless transmission terminal according to the present invention may be data to be reproduced in time sequence such as speech data, not limited to moving image data. The moving image data may or may not include speech data.

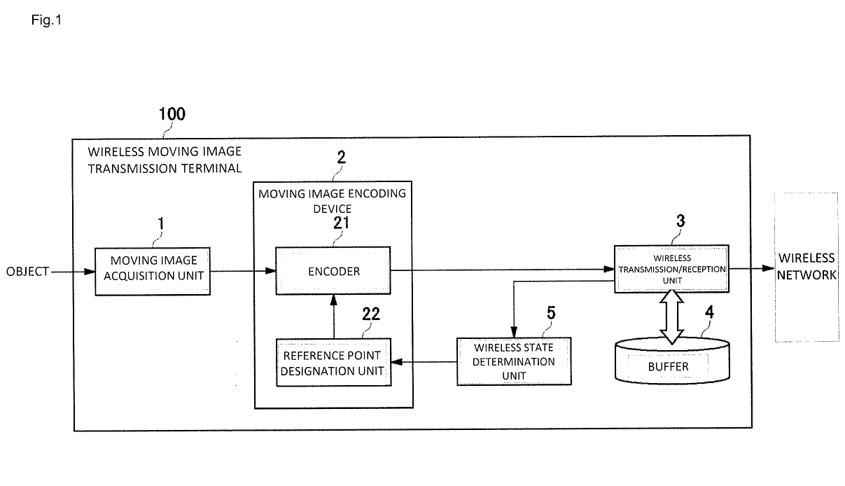

FIG. 1 is a configuration diagram of the wireless moving image transmission terminal according to the embodiment of the present invention. The wireless moving image transmission terminal 100 includes a moving image acquisition unit 1, a moving image encoding device 2, a wireless transmission/reception unit 3, a buffer 4 and a wireless state determination unit 5. The moving image encoding device 2 includes an encoder 21 and a referenced frame designation unit 22.

The moving image acquisition unit 1 is a module for acquiring moving image data, and corresponds to the data acquisition unit according to the present invention. The moving image acquisition unit 1 according to the present embodiment shoots an object and generates moving image data thereby to acquire moving image data. The moving image acquisition unit 1 may read the moving image data recorded in a recording medium thereby to acquire the moving image data. The moving image acquisition unit 1 outputs the acquired moving image data to the encoder 21 in the moving image encoding device 2. The moving image data output from the moving image acquisition unit 1 is data in units of frame. The frames are reproduced in a time order thereby to express a moving image.

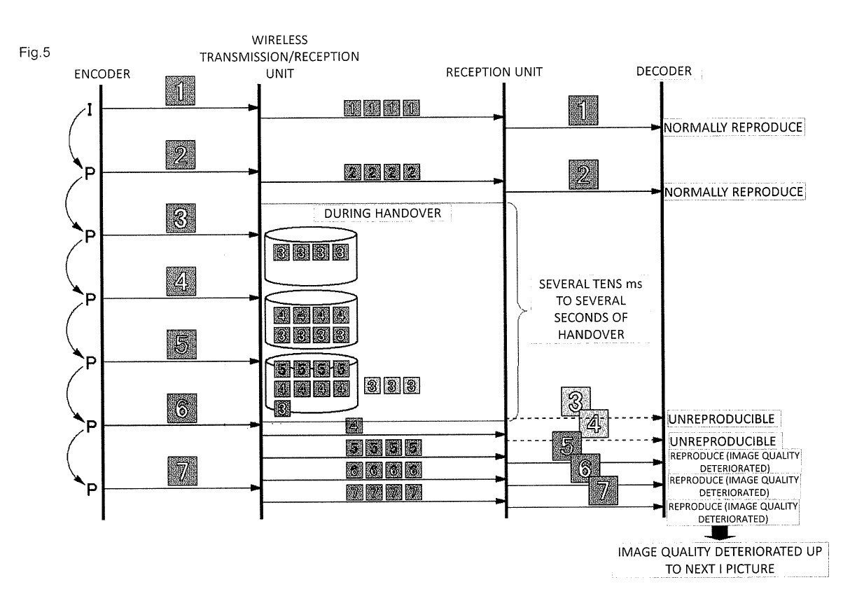

The encoder 21 encodes the moving image data output from the moving image acquisition unit 1 by inter-frame predictive encoding. As described in FIG. 5, in a normal time when the wireless transmission/reception unit 3 can wirelessly transmit/receive data, the encoder 21 encodes the frames of the moving image data into encoded data including in-frame encoding frames (I pictures) and inter-frame encoding frames (P pictures) by inter-frame predictive encoding. That is, each inter-frame encoding frame is generated by forward predictive encoding assuming a previous frame as a frame to be referred to in the inter-frame predictive encoding (which will be called “referenced frame” below). The encoder 21 outputs the encoded data to the wireless transmission/reception unit 3.

The referenced frame designation unit 22 designates a referenced frame for the inter-frame predictive encoding by the encoder 21 when a predetermined condition is met. The designation of a referenced frame by the referenced frame designation unit 22 will be described below in detail.

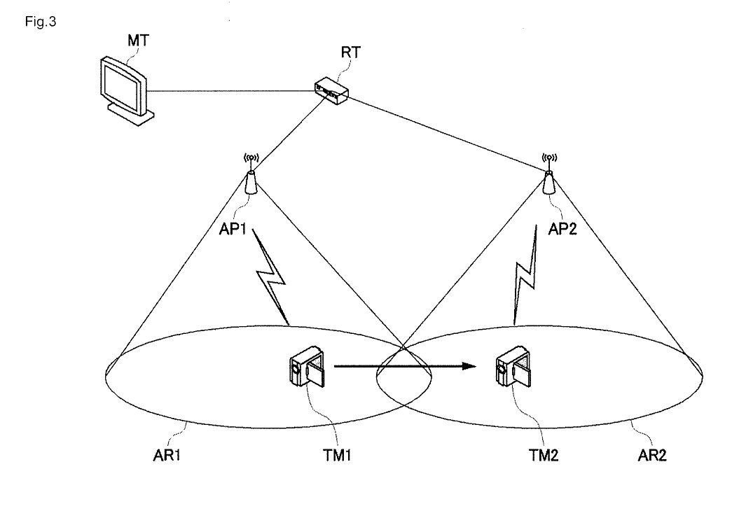

The wireless transmission/reception unit 3 packetizes the encoded data input by the encoder 21, temporarily stores the packets to be transmitted in the buffer 4 as needed, and transmits them toward a wireless network. The wireless transmission/reception unit 3 has a reception function of receiving various control signals or data from the wireless network. Access points are present (see FIG. 3) beyond the wireless network, and the wireless moving image transmission terminal 100 transmits/receives to/from an access point in a wireless area to which the terminal belongs.

The image acquisition unit 1 acquires the frames of a moving image in time sequence, and sequentially outputs the same to the encoder 21. The encoder 21 encodes the frames of the moving image input from the image acquisition unit 1, and generates and outputs encoded data to the wireless communication unit 3. The wireless communication unit 3 sequentially packetizes the encoded data input from the encoder 21, and sequentially transmits the transmission packets in an order of packetization. Thereby, a transmission destination can sequentially decode the moving image shot by the moving image acquisition unit 1, and real-time reproduction at the transmission destination can be realized in this way.

The wireless state determination unit 5 performs a handover processing of the wireless moving image transmission terminal 100. In order to do this, the wireless state determination unit 5 determines whether the wireless state of the wireless transmission/reception unit 3 is good. The wireless state determination unit 5 can determine whether the wireless state is good depending on a wireless intensity received in the wireless transmission/reception unit 3.

When the wireless intensity lowers a predetermined threshold or is equal to or less than the predetermined threshold, the wireless state determination unit 5 determines that the wireless state is deteriorated, and controls the wireless transmission/reception unit 3 to interrupt the transmission of the packets of the encoded moving image data input by the encoder 21. When the wireless intensity is equal to or more than the predetermined threshold or exceeds the predetermined threshold, the wireless state determination unit 5 determines that the wireless state is recovered, and controls the wireless transmission/reception unit 3 to restart the transmission of the packets of the encoded moving image data input by the encoder 21.

The situations for restarting the transmission of the packets of the encoded moving image data include a situation in which after the wireless state is determined to be deteriorated and handover is started, the handover is completed and an association with a new access point is established and a situation in which after the wireless intensity is less than the predetermined threshold or is equal to or less than the predetermined threshold in the wireless communication with an access point, the wireless intensity in the wireless communication with the same access point is equal to or more than the predetermined threshold or exceeds the predetermined threshold.

When determining that the wireless state is deteriorated, the wireless state determination unit 5 notifies the fact to the referenced frame designation unit 22 in the moving image encoding device 2. When determining that the wireless state is recovered, the wireless state determination unit 5 notifies the fact to the referenced frame designation unit 22 in the moving image encoding device 2.

The encoder 21 encodes the frames of the moving image data by the inter-frame predictive encoding illustrated in FIG. 5 during a normal time as described above. That is, the frame 1 is subjected to in-frame encoding to be an I picture, and the frame 2 and its subsequent frames are subjected to forward predictive encoding to be P pictures assuming a previous frame as a referenced frame until a next in-frame encoding frame.

When receiving a notification that the wireless state is determined to be deteriorated from the wireless state determination unit 5, the referenced frame designation unit 22 designates a referenced frame. When the referenced frame designation unit 22 designates a referenced frame, the encoder 21 does not perform normal predictive encoding as illustrated in FIG. 6 until the designation is canceled, and fixes a referenced frame at the designated referenced frame, and performs forward predictive encoding.

When designating a referenced frame, the referenced frame designation unit 22 designates, as a referenced frame, the latest frame which is decodable by itself or by referring to the previously-transmitted frames among the frames all the packets of which are completely transmitted before the wireless state determination unit 5 determines that the wireless state is deteriorated and the transmission of the packets by the wireless transmission/reception unit 3 is interrupted. The self-decodable frames is an in-frame encoding frame (I picture). The frame decodable by referring to the previously-transmitted frames is a forward predictive encoding frame (P picture).

After a referenced frame is designated, the encoder 21 performs forward predictive encoding on the frames of the moving image data sequentially input from the moving image acquisition unit 1 to generate encoded data with the designated referenced frame as a referenced frame. The encoder 21 sequentially outputs the encoded data to the wireless transmission/reception unit 3. The wireless transmission/reception unit 3 packetizes the input encoded data, but cannot transmit the packets and thus stores the same in the buffer 4.

In this way, the wireless transmission/reception unit 3 stores the packets in the buffer 4, and when new packets need to be stored in the buffer 4 after the packets are stored up to the capacity of the buffer 4, the packets of the oldest frame are discarded (erased) from the buffer 4. At this time, the packets are discarded in units of frame, or a plurality of packets configuring one frame is discarded at the same time.

When the wireless state determination unit 5 determines that the wireless state is recovered and the wireless communication is restarted, the wireless transmission/reception unit 3 transmits the packets stored in the buffer 4 sequentially from the oldest frame. When the packets stored in the buffer 4 are extracted and transmitted by the wireless transmission/reception unit 3 while the wireless communication is being interrupted, the wireless transmission/reception unit 3 sequentially stores the encoded data input from the encoder 21 into the buffer 4.

When receiving a notification that the wireless state is recovered from the wireless state determination unit 5, the referenced frame designation unit 22 cancels designation of a referenced frame for the encoder 21. After the referenced frame designation unit 22 cancels the designation of a referenced frame, the encoder 21 performs inter-frame predictive encoding again in the order illustrated in FIG. 6.

For the restart, the encoding may be restarted from either the I picture or the P picture. While the wireless communication is being interrupted, as described above, the referenced frame is fixed on the frame before the wireless communication is interrupted, and the referenced frame for the frame encoded by forward predictive encoding immediately before the wireless communication is restarted is relatively distant from the encoded frame, which can cause a deteriorated image quality. Thus, in terms of rapid recovery of the image quality, the in-frame encoding may be desirably performed immediately after the wireless communication is restarted.

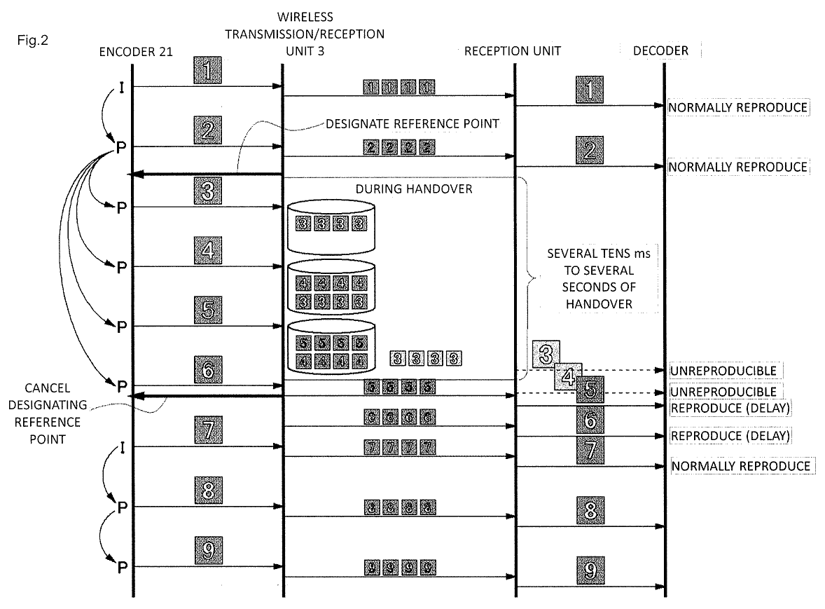

FIG. 2 is a diagram for explaining a moving image data transmission processing at the wireless moving image transmission terminal 100 and a transmission destination. The encoder 21 in the wireless moving image transmission terminal 100 first performs in-frame encoding on the frame 1 to generate an I picture, and the wireless transmission/reception unit 3 packetizes the I picture to be transmitted. Then, the encoder 21 in the wireless moving image transmission terminal 100 encodes the frame 2 into a P picture, and the wireless transmission/reception unit 3 packetizes the P picture to be transmitted.

Thereafter, when the wireless moving image transmission terminal 100 moves to an edge of the wireless area of the access point with which it has communicated so far so that when the reception intensity is deteriorated in the wireless transmission/reception unit 3, the wireless state determination unit 5 determines the deteriorated reception intensity, the transmission of the packets by the wireless transmission/reception unit 3 is interrupted to start the handover processing, and the referenced frame designation unit 22 designates a referenced frame for the encoding in the encoder 21.

The encoder 21 fixes a referenced frame for subsequent encoding at the designated referenced frame according to the designated referenced frame. In the example of FIG. 2, the frame 2 is designated as the latest frame or the referenced frame which is decodable by itself or by referring to the previously-transmitted frames among the frames all the packets of which are completely transmitted before the transmission of the packets by the wireless transmission/reception unit 3 is interrupted.

The encoder 21 performs forward predictive encoding on the frame 3 with the designated frame 2 as a referenced frame, thereby to generate a P picture. The wireless transmission/reception unit 3 cannot transmit the generated P picture of the frame 3, and thus stores the packets in the buffer 4. The encoder 21 performs forward predictive encoding also on the frame 4 with the frame 1 as a referenced frame, thereby to generate a P picture, and the wireless transmission/reception unit 3 stores the packets of the frame 4 in the buffer 4.

Since the designation of the referenced frame is not canceled for the frame 5, the encoder 21 performs forward predictive encoding with the frame 2 as a referenced frame, thereby to generate a P picture. The wireless transmission/reception unit 3 cannot transmit the packets of the frame 5 and thus stores them in the buffer 4, but since the buffer 4 does not have a free capacity for storing all the packets of the frame 5, all the packets of the frame 3 as the oldest frame are discarded to secure a free capacity, thereby storing the packets of the frame 5.

The handover takes several tens milliseconds to several seconds, and a service disconnected period in which communication is interrupted is caused during the period. The handover is completed after the packets of the frame 5 are stored, but the packets of the frame 5 are not transmitted when the frame 6 is packetized, and thus the packets of the oldest frame 4 are discarded and the packets of the frame 6 are stored in the buffer 4.

When the handover is completed, the fact is notified from the wireless state determination unit 5 to the referenced frame designation unit 22, and the referenced frame designation unit 22 cancels the designation of a referenced frame for the inter-frame predictive encoding in the encoder 21. When the handover is completed and the communication is restarted, the wireless transmission/reception unit 3 sequentially transmits the packets stored in the buffer 4.

When the designation of a referenced frame is canceled, the encoder 21 performs in-frame encoding on the first frame thereby to generate an I picture.

The reception unit in the transmission destination receives the packets transmitted from the wireless moving image transmission terminal 100. When receiving the packets of the transmission destination frame 1, the transmission destination decodes and reproduces the packets, and when receiving the packets of the frame 2, it decodes the frame 2 with the frame 1 as a referenced frame. In this way, the frame 1 and the frame 2 are normally reproduced at the transmission destination.

Since the packets are not transmitted from the wireless moving image transmission terminal 100 during handover, reproduction is temporarily stopped at the transmission destination. When the handover ends and the communication is restarted in the wireless moving image transmission terminal 100, the packets of the frame 5 are first transmitted. The frame 3 and the frame 4 are previously discarded in the wireless moving image transmission terminal 100 and are not transmitted to the transmission destination, and thus their frames are not reproduced in the transmission destination.

The transmission destination decodes the frame 5 with reference to the frame 2. The frame 6 is decoded with reference to the frame 2. If the frame 5 is encoded with reference to the previous frame 4 as usual, the frame 4 is discarded due to interrupted communication, and thus, even if the frame 5 stored in the buffer during the interrupted communication is transmitted to the transmission destination after the communication is restarted, a referenced frame for the frame 5 is not present in the transmission destination and cannot be decoded.

According to the present embodiment, as described above, the frames transmitted after the communication is restarted are the frames transmitted to the transmission destination before the communication is interrupted, and are encoded with the decodable frame 2 as a referenced frame, and thus the frames can be accurately decoded from the beginning at the transmission destination after the communication is restarted. Then, the frame 7 and its subsequent frames encoded after the designation of the referenced frame is canceled can be decoded and reproduced as usual.

As described above, according to the present embodiment, also when the transmission of the encoded data by the wireless transmission unit 3 is stopped, not the in-frame encoding frames but the inter-frame encoding frames are generated, and thus for storing the same, a small capacity of the buffer is required, and also when the encoded data stored after the wireless communication is restarted is transmitted, a small amount of data to be transmitted is required. When the transmission of the encoded data by the wireless transmission unit 3 is stopped, the referenced frame designation unit designates a referenced frame for the inter-frame predictive encoding in the encoder, thereby avoiding a situation in which the encoded data transmitted after the wireless state is recovered and the transmission of the encoded data is restarted cannot be decoded due to an absence of a referenced frame in the transmission destination.

According to the present embodiment, the encoder 21 performs encoding (encoding for generating I pictures and P pictures) including only in-frame encoding and forward predictive encoding as normal encoding, but may perform encoding (encoding for generating I pictures, P pictures and B pictures) including in-frame encoding, forward predictive encoding and bidirectional predictive encoding.

In the above embodiment, the wireless moving image transmission terminal 100 has the buffer 4, and stores the frames encoded while communication is being interrupted in the buffer 4, and transmits the frames stored in the buffer 4 after the communication is restarted. As the capacity is larger, the buffer 4 can store more frames acquired and encoded while communication is being interrupted, and more frames can be reproduced at the transmission destination after the communication is restarted, thereby reducing missing frames.

However, the present invention is advantageous in that even when the capacity of the buffer is not sufficient and part of the frames is discarded while communication is being interrupted, the frames transmitted after the communication is restarted can be immediately decoded and reproduced. Thus, the present invention is advantageous when the buffer does not have an enough capacity to store all the frames generated while communication is being interrupted, and further when the capacity of the buffer is so small or the buffer is not present.

In the present embodiment, when the capacity of the buffer is not enough and thus part of the frames should be discarded, the frames are sequentially discarded from the oldest frame, but the present invention is not limited thereto. For example, the frames may be discarded at predetermined intervals (such as only odd-numbered frames) from the oldest frame, or the frames to be discarded may be determined by any other method. The frames are intermittently discarded (or left) so that after communication is restarted, not only a moving image immediately after the restart but also former frames can be reproduced at the transmission destination. In this way, the frames to be discarded (or left) can be determined by any other method because a referenced frame for the frames encoded while communication is being interrupted is fixed on a decodable frame at the transmission destination irrespective of the interrupted communication.

When the normal encoding is encoding with reference to a frame before multiple frames, a referenced frame is kept designated for several frames after communication is restarted, and the frames are encoded, and the designated referenced frame may be then canceled such that the inter-frame encoding frames after communication is restarted to return to the normal encoding are not encoded with reference to the frames which cannot be stored in the buffer to be discarded due to the interrupted communication.

According to the embodiment, when the reception intensity in the wireless transmission/reception unit 3 lowers the predetermined threshold or is equal to or less than the predetermined threshold, the wireless state determination unit 5 determines that the wireless state is deteriorated, and interrupts transmission of the packets by the wireless transmission/reception unit 3, and notifies the fact to the referenced frame designation unit 22, but the present invention is not limited thereto. When handover is started, the wireless state determination unit 5 may determine that the wireless state is deteriorated, and may notify the fact to the referenced frame designation unit 22. The wireless state determination unit 5 may determine that the wireless state is recovered based on an association established with a new access point when the handover is completed.

The preferred embodiment according to the present invention considered so far has been described above, but the present embodiment may be variously modified, and the scope of claims intends to encompass all the variants within the spirit and scope of the present invention.

### INDUSTRIAL APPLICABILITY

As described above, the present invention can avoid a situation in which since a referenced frame for inter-frame predictive encoding in the encoding is designated while transmission of encoded data is being interrupted, a transmission destination cannot decode the encoded data transmitted after a wireless state is recovered and the transmission of the encoded data is restarted due to an absence of a referenced frame, and is advantageous as a wireless transmission terminal for encoding and wirelessly transmitting data to be reproduced in time sequence by inter-frame predictive encoding.

### REFERENCE SIGNS LIST

1 MOVING IMAGE ACQUISITION UNIT
2 MOVING IMAGE ENCODING DEVICE
3 WIRELESS TRANSMISSION/RECEPTION UNIT
4 BUFFER
5 WIRELESS STATE DETERMINATION UNIT
21 ENCODER
22 REFERENCE POINT DESIGNATION UNIT
100 WIRELESS MOVING IMAGE TRANSMISSION TERMINAL

1-17. (canceled)

18. A wireless transmission terminal for encoding and wirelessly transmitting moving image data, comprising:
a data acquisition unit for shooting an object and acquiring the moving image data;
an encoder for encoding the data acquired in the data acquisition unit by inter-frame predictive encoding in units of frame and generating encoded data;
a wireless transmission unit for wirelessly transmitting the encoded data;
a wireless transmission control unit for, when determining that a wireless state is deteriorated based on a reduction in a reception intensity or start of handover, interrupting transmission of the encoded data by the wireless transmission unit; and
a referenced frame designation unit for designating, as a referenced frame for the inter-frame predictive encoding in the encoder, the latest frame which is decodable by frames transmitted before the wireless transmission control unit interrupts transmission of the encoded data by the wireless transmission unit.

19. The wireless transmission terminal according to claim 18, comprising a buffer for storing the encoded data to be transmitted by the wireless transmission unit while the wireless transmission control unit interrupts transmission of the encoded data by the wireless transmission unit.

20. The wireless transmission terminal according to claim 18, wherein after the wireless transmission control unit determines that the wireless state is recovered, the wireless transmission unit transmits the encoded data stored in the buffer.

21. The wireless transmission terminal according to claim 18, wherein after the wireless transmission control unit determines that the wireless state is recovered, the referenced frame designation unit cancels the designation of the referenced frame.

22. The wireless transmission terminal according to claim 21, wherein after the wireless transmission control unit determines that the wireless state is recovered, and a predetermined number of frames are encoded using the designated referenced frame, the referenced frame designation unit cancels the designation of the referenced frame.

23. The wireless transmission terminal according to claim 19, wherein when receiving the encoded data exceeding a capacity of the buffer, the buffer discards the stored encoded data in units of frame.

24. The wireless transmission terminal according to claim 23, wherein the buffer discards the stored encoded data sequentially from the oldest data.

25. The wireless transmission terminal according to claim 23, wherein the buffer discards the stored encoded data at predetermined frame intervals sequentially from the oldest data.

26. The wireless transmission terminal according to claim 18, wherein until handover is completed after the wireless transmission terminal starts the handover, the wireless transmission control unit interrupts transmission of the encoded data by the wireless transmission unit.

27. An encoding device used for a wireless transmission terminal comprising a data acquisition unit for shooting an object and acquiring moving image data, a wireless transmission unit for encoding the moving image data by inter-frame predictive encoding in units of frame and wirelessly transmitting the encoded data, and a wireless transmission control unit for, when determining that a wireless state is deteriorated based on a reduction in a reception intensity or start of handover, interrupting transmission of the encoded data by the wireless transmission unit,
the encoding device comprising:
an encoder for encoding the data acquired by the data acquisition unit by inter-frame predictive encoding in units of frame and generating the encoded data; and
a referenced frame designation unit for designating, as a referenced frame for the inter-frame predictive encoding in the encoder, the latest frame which is decodable by frames transmitted before the wireless transmission control unit interrupts transmission of the encoded data by the wireless transmission unit.

28. A wireless transmission method for encoding and wirelessly transmitting moving image data, comprising:
a data acquisition step of shooting an object and acquiring moving image data;
an encoding step of encoding the data acquired in the data acquisition step by inter-frame predictive encoding in units of frame and generating encoded data;
a wireless transmission step of wirelessly transmitting the encoded data;
a wireless transmission control step of, when determining that a wireless state is deteriorated based on a reduction in a reception intensity or start of handover, interrupting transmission of the encoded data; and
a referenced frame designation step of designating, as a referenced frame for the inter-frame predictive encoding in the encoder, the latest frame which is decodable by frames transmitted before the wireless transmission control step interrupts transmission of the encoded data.

29. An encoding method performed in a wireless transmission terminal comprising a data acquisition unit for shooting an object and acquiring moving image data, a wireless transmission unit for encoding the moving image data by inter-frame predictive encoding in units of frame and wirelessly transmitting the encoded data, and a wireless transmission control unit for, when determining that a wireless state is deteriorated based on a reduction in a reception intensity or start of handover, interrupting transmission of the encoded data by the wireless transmission unit,
the encoding method comprising:
an encoding step of encoding the data acquired by the data acquisition unit and to be reproduced in time sequence by inter-frame predictive encoding in units of frame and generating the encoded data; and
a referenced frame designation step of designating, as a referenced frame for the inter-frame predictive encoding in the encoder, the latest frame which is decodable by frames transmitted before the wireless transmission control unit interrupts transmission of the encoded data by the wireless transmission unit.

30. A computer-readable storage medium having stored therein a computer program for causing a computer to perform the wireless transmission method according to claim 28.

31. A computer-readable storage medium having stored therein a computer program for causing a computer to perform the encoding method according to claim 29.
